(19) United States
(12) Patent Application Publication
(10) Pub. No.: US 2011/0157347 A1
(43) Pub. Date: Jun. 30, 2011

(54) UNINTRUSIVE BIOMETRIC CAPTURE DEVICE, SYSTEM AND METHOD FOR LOGICAL ACCESS CONTROL

(76) Inventor: Peter Kalocsai, Clovis, CA (US)

(21) Appl. No.: 12/982,922

(22) Filed: Dec. 31, 2010

Related U.S. Application Data
(60) Provisional application No. 61/291,393, filed on Dec. 31, 2009.

(51) Int. Cl. H04N 7/18; G06K 9/00

(52) U.S. Cl. 348/78; 382/117; 348/E07.085

(57) ABSTRACT

An unintrusive and unobtrusive biometric capture device, system and method is described for providing logical access to users via biometric identification or authentication. When a user positions himself/herself in front of a computing device the biometric capture device attached to the monitor portion of the computing device automatically captures iris and face based live biometric data of the user. Next, live biometric templates are produced from the live image data. Then matching of the live templates against stored ones in a database is performed.

### CROSS-REFERENCE TO RELATED APPLICATIONS

This application claims priority under 35 U.S.C. §119(e)(1) and 37 C.F.R. §1.78(a)(4) to U.S. provisional application Ser. No. 61/291,393 filed Dec. 31 2009 and titled UNINTRUSIVE BIOMETRIC CAPTURE DEVICE, SYSTEM AND METHOD FOR LOGICAL ACCESS CONTROL.

### FEDERALLY SPONSORED RESEARCH

Not applicable

### SEQUENCE LISTING OR PROGRAM

Not applicable

### FIELD OF THE INVENTION

Embodiments of the present invention relate generally to the field of identification, authentication and computer security. More precisely, embodiments of the present invention relate to biometric(s) based identification, authentication and security. Still more particularly, embodiments of the present invention relate to limiting logical access to: computer devices, networks, websites, applications, online shopping, files and folders, based on a user's biometric information.

### BACKGROUND OF THE INVENTION

Authentication is the process of establishing confidence in user identities. In other words it is the process of determining whether someone is in fact who he/she claims to be. It is well accepted that one of the strongest ways of authentication and also of identification is the one based on biometrics. As opposed to utilizing something the user has or knows biometric based identification and authentication is directly based on something the user is.

There are many forms of fingerprint based logical access methods and devices known in the prior art. However, due to the very nature of fingerprint based biometrics this type of authentication or identification method requires the full cooperation of the user. When using fingerprint sensors the user is required the either position or swipe his/her finger in a way that would be acceptable for the given sensor. In other words the user is required to perform an operation that would result in producing sufficient quality fingerprint image on the sensor. This could present some difficulties for certain unhabituated users when operating the device.

There have been other authentication and identification methods proposed—for example in U.S. patent 2007/0094509 (2007) to Wei et al. However, their system and method requires the existence of a certificate directory and various authorities, none of which is required for our system and method. Yet other authentication methods such as in U.S. Pat. No. 6,256,737 (2001) to Bianco et al. describe biometric policies and digital certificates among other components. Similarly, none of those are required to perform identification in our simplified, yet highly efficient system and method.

There have been numerous examples in the prior art suggesting the use of iris and/or face biometric for logical access control. However, none of those descriptions emphasized the collection of iris and face biometric data unintrusively, unobtrusively, and without cooperation from the user or even without the user necessarily noticing the capture process. Unintrusiveness and unobtrusiveness are key elements of the identification and authentication system and method presented here.

### BRIEF SUMMARY OF THE INVENTION

The present invention answers the following question: how to provide biometric based logical access control the most user-friendly way. As mentioned above the prior art contains numerous biometric solutions where a key element of those solutions is describing how the user interacts with the given biometric device, system or method. The goal of the present invention is to make that interaction as invisible as possible.

Embodiments of the present invention describe a completely unintrusive and unobtrusive way of providing biometrics based logical access. In our method biometric based authentication or identification is performed without the user's cooperation and even without the user necessarily noticing it.

Embodiments of the invention take advantage of the observation that when a user uses a computing device he or she is typically facing that device. This positioning is already enough so that a biometric capture device attached to the computing device could reliably and automatically collect face and iris biometrics of the user. According to embodiments of the invention the user is not required to perform any additional act to be identified for logical access. After being enrolled on a computing device or system the biometric authentication process becomes automatic.

It should also be pointed out that other biometrics beside face and iris do not lend themselves so easily for automatic capture and that is why only these two modalities are described in embodiments of the invention.

### BRIEF DESCRIPTION OF THE DRAWINGS

Preferred embodiments of the present invention are illustrated by way of example, and not by way of limitation. For a detailed description of the preferred embodiments of the invention, reference will now be made to the accompanying drawings in which:

FIG. 1 is an illustration of an unintrusive biometric capture device having a camera, illumination means and transfer means;

FIG. 2 is an illustration of an unintrusive biometric system having a capture device, computing device, transfer means and a biometric database;

FIG. 3 is an illustration of an unintrusive biometric system having a capture device, monitor and transfer means;

FIG. 4 is an illustration of a biometric capture device integrated into a computing device;

FIG. 5 is a flow diagram of an unintrusive biometric method for logical access control;

FIG. 6 is a diagram describing the various logical access scenarios;

### DETAILED DESCRIPTION OF THE PREFERRED EMBODIMENTS

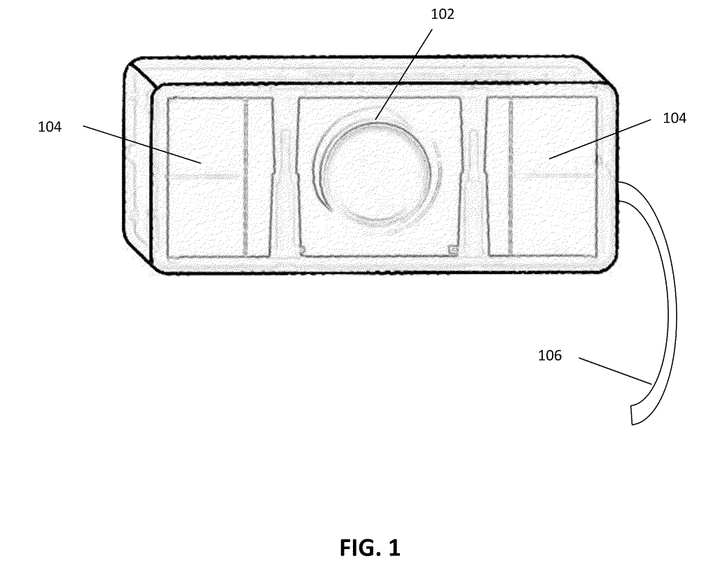

Referring to FIG. 1, an embodiment of the unintrusive biometric capture device is shown. The biometric device includes a camera 102 capable of capturing iris and face images of a user without the user even noticing that the capture process is taking place. The biometric device also includes at least one illumination panel 104 to assure that the captured image or images are bright enough and are of sufficient quality for further processing. The biometric device transfers the collected image data to a computing device via a connecting cable 106. The connecting cable may be a USB cable, network cable, serial cable, or any other interface cable capable of transmitting the image data from the biometric device to the computing device.

In another embodiment of the invention the image data may be transmitted from the biometric capture device to the computing device wirelessly via a Wi-Fi, Bluetooth or any other wireless connection.

In yet another embodiment of the invention the biometric capture device has onboard computing and data storage capability. In this embodiment all the template creation, matching and template storage functionalities are performed within the biometric device itself. In this case only the final outcome of the matching process is communicated to the computing device in a wired or wireless way.

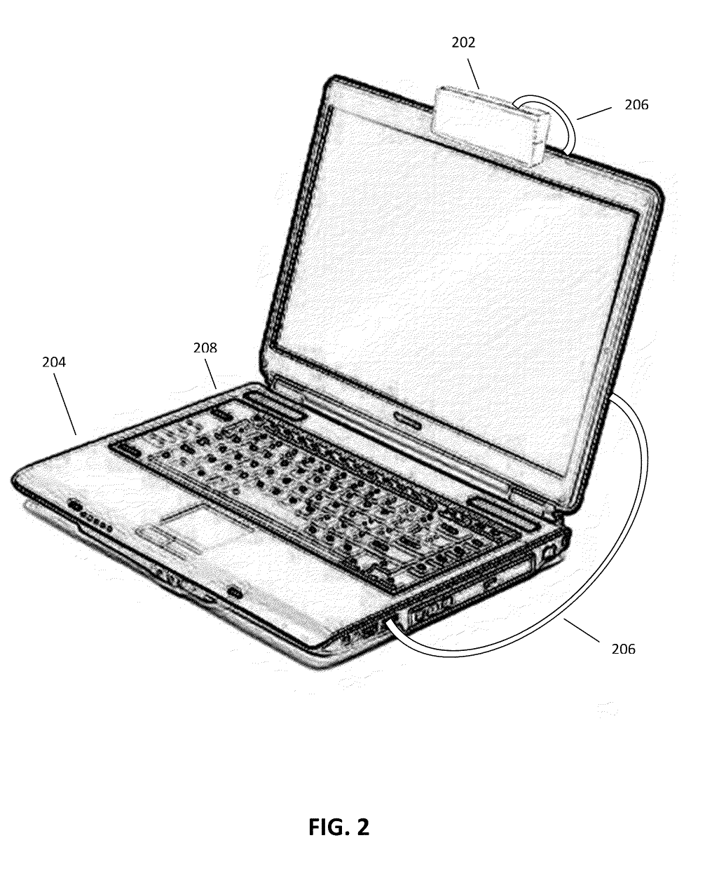

Referring to FIG. 2, an embodiment of the unintrusive biometric system is shown. The unintrusive and unobtrusive biometric system consists of a biometric capture device 202, which is capable of capturing iris and face images of a user without the user's cooperation and even without the user necessarily realizing that the capture process is taking place. Furthermore the system consists of a computing device 204 which performs all the image processing, template creation, template storage and matching functionalities of the entire biometric system. A connecting cable 206 provides means to transfer biometric image data from the biometric capture device to the computing device. In addition, there is a biometric database 208 within the computing device which stores all the enrollment templates within the system. The computing device is configured to be able to create templates from the image data that it receives from the biometric capture device. It can also match live templates against enrolled templates that are stored in the biometric database.

As described before, in another embodiment of the invention the image data may be transmitted from the biometric capture device to the computing device wirelessly via a Wi-Fi, Bluetooth or any other wireless connection.

In another embodiment of the invention the biometric capture device has onboard computing and data storage capability so that it can perform template creation, matching and template storage functionalities within the biometric device itself. In this case only the final outcome of the matching process is communicated to the computing device in a wired or wireless way.

As a way of illustration and not as limitation the biometric capture device 202 is placed at the top portion of the computing device 204. Due to this configuration the biometric capture device is able to capture biometric data of the user automatically by the user simply looking at the monitor or even looking in the general direction of the monitor of the computing device. In another embodiment of the invention the biometric capture device could be positioned at the bottom portion of the monitor of the mobile computing device instead of the top one. In yet another embodiment of the invention the biometric capture device is positioned on either side of the monitor of the computing device.

The computing device may be a mobile one: such as a laptop, smartphone, notebook, netbook or any other mobile computing device. Alternatively, it may also be a stationary computing device: such as a personal computer (PC), workstation, or server.

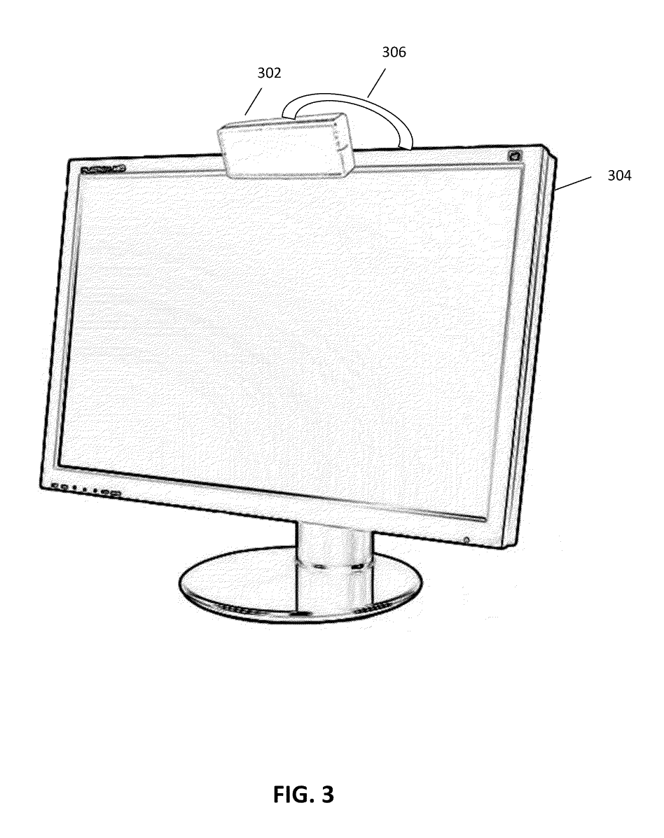

Referring to FIG. 3, another embodiment of the unintrusive biometric system is shown. Here the biometric capture device 302 attached to a monitor 304 of a personal computer (PC), workstation, server or any other stationary computing device according to an embodiment of the present invention is illustrated. As a way of illustration and not as limitation the biometric device is attached to the top portion of the monitor of the stationary computing device. Due to this configuration the biometric sensor device is able to capture biometric data of the user automatically by the user simply looking at the monitor or even looking in the general direction of the monitor. In another embodiment of the invention the biometric sensor device may be placed on the bottom portion of the monitor instead of the top one. In yet another embodiment of the invention the biometric sensor device is placed on either side of the monitor. The biometric capture device 302 is connected to the stationary computing device via a connecting cable 306. In yet another embodiment of the invention instead of a connecting cable wireless connection may also be used.

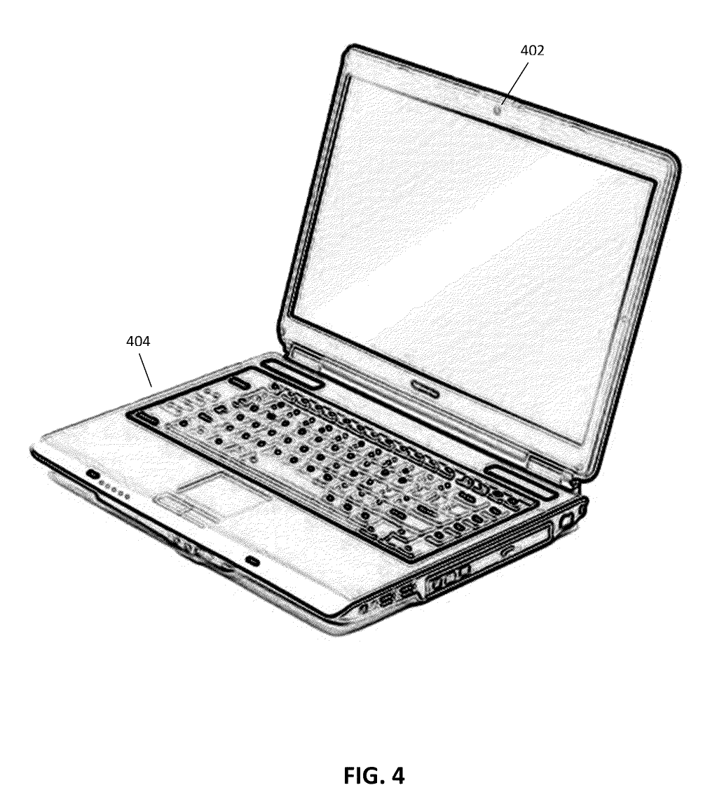

Referring to FIG. 4, a biometric capture device integrated into a laptop, smartphone, notebook, netbook or any other mobile computing device according to an embodiment of the present invention is illustrated. As a way of illustration and not as limitation the biometric device is integrated at the top portion of the mobile computing device. Due to this configuration the biometric sensor device is able to capture biometric data of the user automatically by the user simply looking at the monitor or even looking in the general direction of the monitor of the mobile computing device. In another embodiment of the invention the biometric capture device could be integrated at the bottom portion of the monitor of the mobile computing device instead of the top one. In yet another embodiment of the invention the biometric capture device is positioned on either side of the monitor of the mobile computing device.

In another embodiment of the invention the biometric capture device may be integrated into the monitor of a stationary computing device such as a PC, workstation or server.

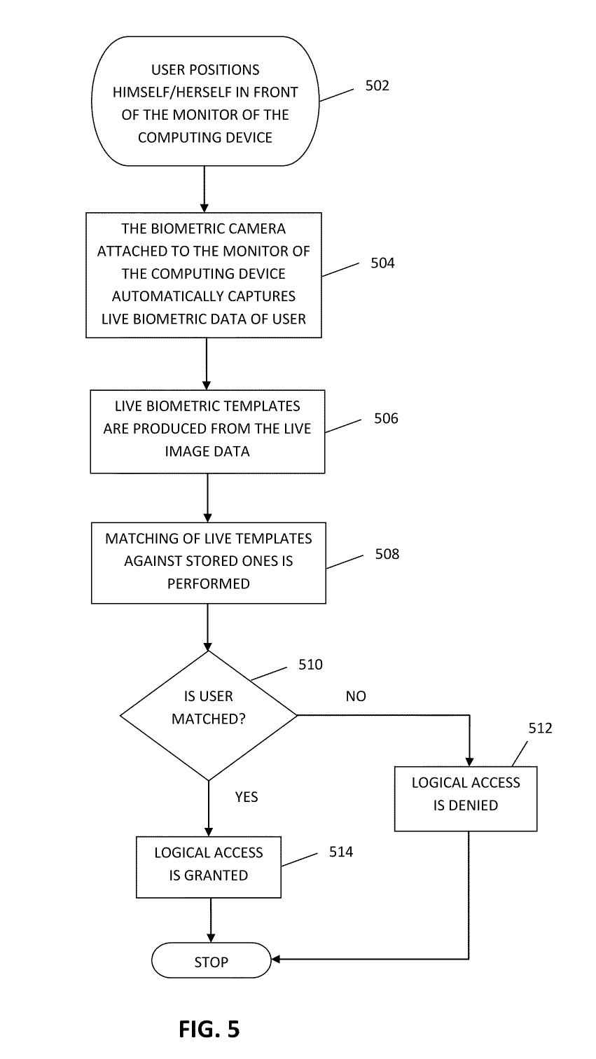

Referring to FIG. 5, a flowchart is show describing the steps for unobtrusively and effortlessly granting logical access to a user of a computing device. In one embodiment of the invention unintrusive biometric identification of a user is achieved by the user simply positioning himself/herself in front of the monitor of a computing device 502. Without any additional effort from the user the biometric device attached to the monitor of the computing device automatically senses motion and starts searching for biometric features when a user is positioned in front of it. When facing the monitor of the computing device the biometric camera automatically captures at least one biometric feature of the user 504. These biometric features could be either irises or the face of the user. From the captured one or more features the biometric application creates live templates 506 which it then matches against its database of enrolled users 508. When the obtained match score is above a predetermined threshold it is considered a match. If a match is found 510 then logical access is granted to the user 514. If no match is found then logical access is denied to the user 512.

Still referring to FIG. 5, in another embodiment of the invention while the user positions himself/herself in front of the monitor of a computing device 502 a login screen is presented to the user before she/he can start working on the computing device. The user chooses his or her own login icon on the monitor. At this point the biometric camera is activated which starts searching for biometric features in its visual field. One or more biometric features should easily be found without any extra effort from the user 504. When clicking on the login icon the user is already facing the monitor and the biometric camera installed on the top portion of the monitor of the computing device. When facing the monitor it exposes the biometric features of the user in direct line of the camera. Once one or more biometric features are found, such as irises or the face, the biometric program creates live templates of the found features 506. In the next step the live templates are matched against the stored ones of the particular user 508. If a match is found then, just as before, logical access is granted to the authenticated user 514. If there is no match found then access is denied 512. Notice, that by clicking on a login icon, the previous automatic identification process is now changed to an authentication process whereby the user's claimed identity is verified. Hence authentication is not entirely automatic. It requires first form the user to claim an identity by clicking on a login icon.

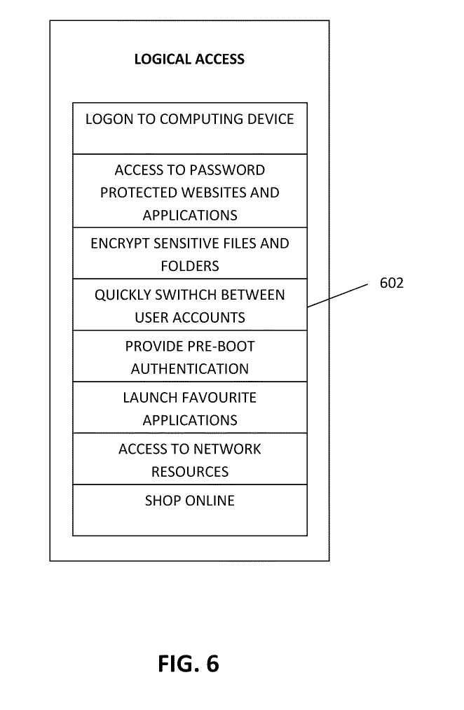

When due to successful matching the user is granted logical access this may mean access to a number of different resources that might otherwise be password protected. Referring to FIG. 6, only as a way of illustration and not as limitation the diagram lists a number of these logical access scenarios 602. One of the most important types of access scenarios is the ability to logging into the computing device itself. By implementing pre-boot identification the computing device could even be prevented from turning on without the user presenting matching live biometric data. The biometric device and method could also provide access to password-protected websites and applications or network resources such as intranets, the internet, database and other servers. It could also be required to encrypt sensitive files and folders, quickly switching between user accounts, launching favorite applications, and shopping online just to name a few potential logical access scenarios.

Please note that the words unintrusive, unobtrusive and effortless are used interchangeably throughout this document all pertaining to the meaning that the user's biometric information is obtained without its cooperation and help.

In another embodiment of the invention the unintrusive biometric method is integrated into the Windows Biometric Framework. Our goal with integrating the present invention into WBF is to provide a unified biometric user experience for various logical access functions.

What is claimed is:

1. An unintrusive biometric capture device, said device comprising:
a camera capable of collecting iris and face images without the user's cooperation,
an illumination means to illuminate faces and irises,
a transfer means for transferring the collected biometric images to a computing device.

2. The unintrusive biometric capture device of claim 1, wherein said transfer means is a USB cable, network cable, serial cable, or any other interface cable capable of transferring the image data from the biometric capture device to the computing device.

3. The unintrusive biometric capture device of claim 1, wherein said transfer means is a Wi-Fi, Bluetooth, or any other wireless connection capable of transferring the image data from the biometric capture device to the computing device.

4. The unintrusive biometric capture device of claim 1, wherein said camera, illumination means and transfer means are built into the computing device itself.

5. The unintrusive biometric capture device of claim 1, wherein said camera, illumination means and transfer means are built into the monitor of the computing device.

6. An unintrusive biometric system performing logical access control, said system comprising:
a biometric device capable of collecting iris and face images without the user's cooperation,
a computing device,
a transfer means for transferring the collected biometric images from the said biometric device to the said computing device,
a biometric database stored on said computing device with at least one biometric template stored in it
wherein said computing device is configured to be able to create templates from said iris and face images and match them against at least one stored template in said biometric database.

7. The unintrusive biometric system of claim 6, wherein said computing device is a laptop.

8. The unintrusive biometric system of claim 6, wherein said computing device is a personal computer, workstation, or server.

9. The unintrusive biometric system of claim 6, wherein said computing device is a smartphone.

10. The unintrusive biometric system of claim 6, wherein said computing device is a notebook, netbook, or any other mobile computing device.

11. The unintrusive biometric system of claim 6, wherein said computing device is an iPad or a Tab.

12. The unintrusive biometric system of claim 6, wherein said biometric device and said computing device are one integrated unit.

13. The unintrusive biometric system of claim 6, wherein said biometric device is located at the top portion of the computing device's monitor.

14. The unintrusive biometric system of claim 6, wherein said biometric device is located at the bottom portion of the computing device's monitor.

15. The unintrusive biometric system of claim 6, wherein said biometric device is located on either side of the computing device's monitor.

16. An unintrusive method for identifying a user for logical access in a biometric identification system, the biometric identification system comprising of a biometric capture device, a computing device and a database of enrolled users stored on the computing device with at least one biometric template stored in it wherein the following steps are performed:
capturing, the user's live iris and face images automatically via said biometric capture device
performing, live template creation from the live biometric image data on said computing device
performing, on said computing device the matching of live templates to stored ones in the said database of enrolled users
performing, granting logical access to user if the user is matched, otherwise denying logical access

17. The unintrusive method for identifying a user of claim 16, wherein as a first step the user chooses his or her login icon from the login screen on the said computing device's monitor. The choosing of a login icon activates the said biometric capture device which starts capturing live iris and face images.

18. The unintrusive method for identifying a user of claim 16, wherein the said biometric capture device and the computing device are one integrated unit.

19. The unintrusive method for identifying a user of claim 16, wherein the said biometric capture device only captures iris images.

20. The unintrusive method for identifying a user of claim 16, wherein the said biometric capture device only captures face images.
